(19) United States
(12) Patent Application Publication
(10) Pub. No.: US 2008/0017129 A1
(43) Pub. Date: Jan. 24, 2008

(54) COLLAPSIBLE, PORTABLE ANIMAL SHELTER OR CARRIER

(76) Inventor: David Dizon, San Antonio, TX (US)

Correspondence Address: NEIL J. COIG, 2355 DRUSILLA LANE, BATON ROUGE, LA, 70809, US

(21) Appl. No.: 11/776,540

(22) Filed: Jul. 11, 2007

Related U.S. Application Data
(63) Continuation-in-part of application No. 10/353,466, filed on May 13, 2003, now abandoned.

(51) Int. Cl. A01K 1/03

(52) U.S. Cl. 119/498

(57) ABSTRACT

A collapsible, portable animal shelter or carrier having air holes, a carrying handle and an animal access door that could be rapidly configured between a substantially flat configuration for easy storage or shipping and portable shelter or carrier configuration for holding an animal.

### CONTINUATION HISTORY

This application is a continuation-in-part of U.S. patent application Ser. No. 10/353,466, filed on May 13, 2003, which is hereby incorporated by reference in its entirety.

### TECHNICAL FIELD

The present invention relates to a pet and animal care accessories and a more particularly to a collapsible, portable animal shelter or carrier that includes a cut-out member having a number of crease lines, locking tabs protruding from the roof, air holes, two hands hold holes, and a movable, lockable animal access door arranged thereon such that the cut-out member may be folded and portions thereof secured together by the locking tabs protruding from the roof and a glue tab to form a collapsible, portable animal shelter or carrier having air holes, a carrying handle formed from the two hand holes and an animal access door.

### BACKGROUND OF THE INVENTION

It is often difficult for people with pets to travel with them or to take them for medical treatment because of the fear the pet will run off and be injured. Many people use a pet carrier to hold the pet in a confined area while transporting the animal. Although these pet carriers work well, they are difficult to store because of their relatively large size. Some other carriers which are collapsible require much more manipulation to assemble and may require two or more halves to make a whole carrier and require the same extensive manipulation to collapse them. Others once assembled and the adhesive strips connected would be very difficult to collapse for storage. It would be desirable therefore, to have a collapsible, portable animal shelter or carrier that is much simpler to assemble and collapse using the novel and nonobvious locking tabs protruding from the roof, having air holes, a carrying handle and a animal access door and that could be rapidly configured between a substantially flat configuration for easy storage or shipping and a portable animal shelter or carrier configuration for holding an animal.

### OBJECTS OF THE INVENTION

One object of the invention is to provide a portable transporter for animals.

Another object of this invention is to provide an easily assembled portable transporter for animals.

Yet another object of this invention is to provide a collapsible portable transporter for animals.

Still another object of this invention is to provide transporter for animals with improved locking tabs.

Other objects and advantages of this invention shall become apparent from the ensuing descriptions of the invention.

### SUMMARY OF THE INVENTION

According to the present invention, it is an object of the invention to provide a collapsible, portable animal shelter or carrier that includes a cut-out member having a number of crease lines, locking tabs, air holes, two hand hold holes, and a movable, lockable animal access door arranged thereon such that the cut-out member may be folded and portions thereof secured together by the locking tabs protruding from the roof and a glue tab at the base to form a collapsible, portable animal shelter or carrier having air holes, a carrying handle formed from the two hand holes, and an animal access door.

Accordingly, a collapsible, portable animal shelter or carrier is provided.

The collapsible, portable animal shelter or carrier includes a cut-out member having a number of crease lines, locking tabs protruding from the roof, air holes, two hand hold holes, and a movable, lockable animal access door arranged thereon such that the cut-out member may be folded and portions thereof secured together by a glue tab at the base and the locking tabs protruding from the roof to form a collapsible, portable animal shelter or carrier having air holes, a carrying handle formed from the two hand holes, and an a animal access door.

### BRIEF DESCRIPTION OF THE DRAWINGS

The accompanying drawings and figures illustrate an embodiment of this invention. However, it is to be understood that this embodiment is intended to be neither exhaustive, nor limiting of the invention. They are but examples of some of the forms in which the invention may be practiced.

FIG. 1 is a plan view of an exemplary embodiment of the cut-out member of the collapsible, portable animal shelter or carrier of the present invention laid out flat in the collapsed configuration prior to being folded and interconnected to form a portable animal shelter or carrier.

FIG. 2 is a side front view of the collapsible, portable animal shelter or carrier folded into the shelter or carrier configuration. The arrows depict folding to the flat storage configuration.

FIG. 3 is a detail view of, section 3-3 depicting the locking tabs protruding from the roof provided to hold varies sections of the cut-out member together to maintain the cut-out member in the locked configuration to hold the front and back panels in the upright animal shelter or carrier configuration. The phantom lines depict the inward direction the front and back panels fold to a flat position.

FIG. 4 is a perspective view of the collapsible, portable animal shelter or carrier in the assembled animal shelter or carrier configuration.

FIG. 5 is a perspective view of the locking tabs of the invention.

### DETAILED DESCRIPTION OF EXEMPLARY EMBODIMENTS

Without any intent to limit the scope of this invention, reference is made to the figures in describing the various embodiments of the invention. The figures and drawings show various aspects of exemplary embodiments of the present invention.

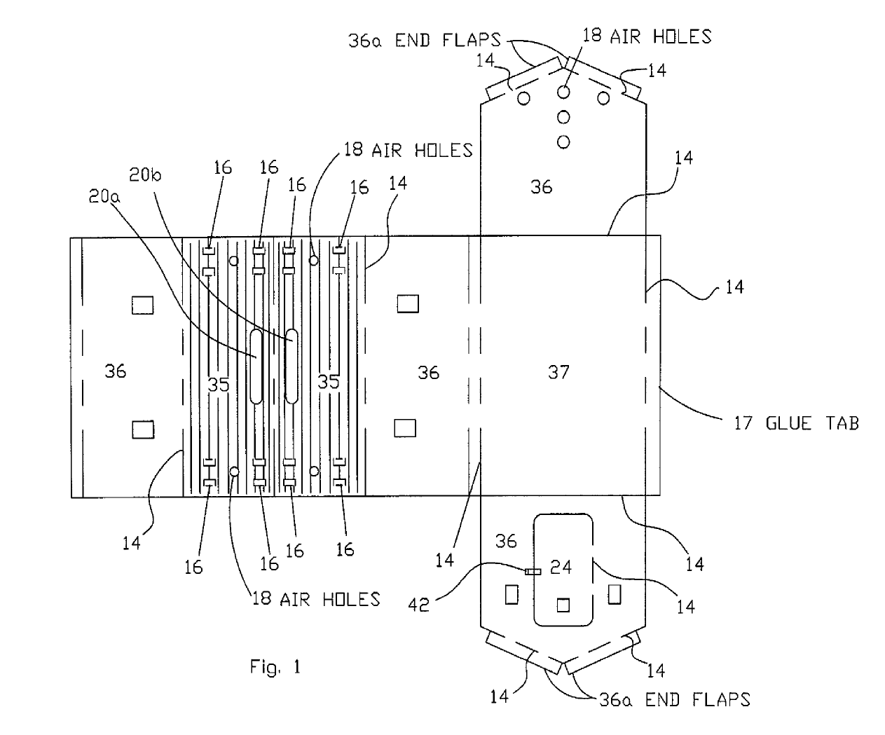

FIGS. 1-5 show various aspects of an exemplary embodiment of the collapsible, portable animal shelter or carrier of the present invention. Collapsible, portable animal shelter or carrier includes a cut-out member, having a number of crease lines 14, tabs 16, air holes 18, two hand hold holes 20a, 20b, a glue covered attachment tab 17 and a moveable, lockable animal access door 24 arranged thereon such that the cut-out member may be folded and portions thereof secured together by a plurality of locking tabs 16 to form a collapsible, portable animal shelter or carrier, having air holes 18 formed through sidewalls 36, a carrying handle 40 formed from the two hand holes 20a, 20b, and an animal access door 24 that is lockable with a hook and pile locking strip assembly 42. Locking tabs 16 are a novel design, since they are constructed by perforating a shape in a panel, such as the roof, wherein the shape cut, such as a square, is die cut on all but one side, enabling the tab to be folded inward. Having a series of locking tabs 16 in parallel rows with a space between enables them to create a channel for a wall section, such as end flap, to lock in as seen in FIG. 3.

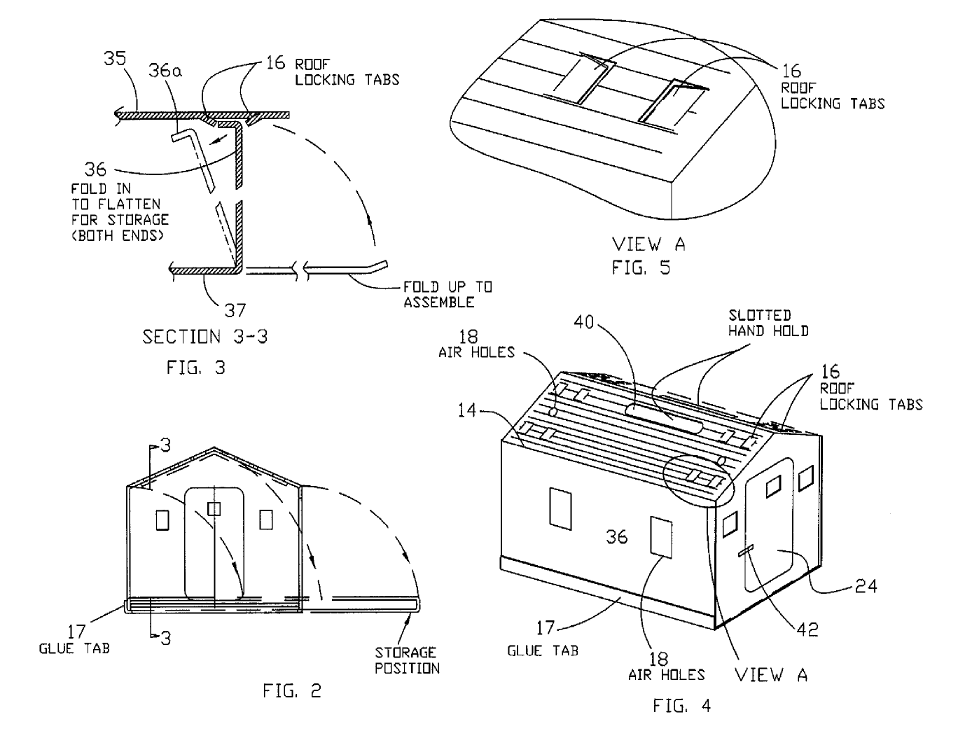

FIG. 1 includes a cut-out member in the flat configuration. FIG. 1 depicts side, front and back panels 36, roof panel 35, floor panel 37, and end flaps 36a, door latch 42, air holes 18, glue tab 17, two hand hold holes 20a, 20b, when assembled create hand hold 40, FIGS. 2 and 4 depict the assembled configuration. To assemble the collapsible and portable animal shelter or carrier requires the following steps. First all the panels will be pre-bent along the crease lines 14. FIG. 1 is then folded along the crease lines where the long edge of 36 overlaps the long edge of glue tab 17 which allows glue tab 17 to be attached to the outside of panel 36 as seen in FIG. 2 and 4. The roof panels are then lifted away from the floor panel allowing room for front panel 36 and end flaps 36a to be slipped inside and below the roof panels as shown in FIG. 3, section 3-3. Tabs 16 will be pushed slightly downward forming the locking tabs protruding from the roof. The locking tabs will engage both sides of the end flaps of panel 36 locking the front panel in the vertical position. Repeat the same steps for back panel 36 and end flaps. To fold the collapsible and portable animal shelter or carrier for storage, place the index finger of each hand through the two air holes located between the roofs locking tabs directly over the 36 end flaps.

Press the end flaps downward releasing the engagement between the end flaps 36 and the inner roof locking tabs 16 and pushing with the thumbs fold 36 front panel inward to the flat position and repeat the same for 36 back panel. With both front and back panels 36 folded flat you now can fold side panels 36 to the right or left to the collapsed storage configuration as shown in FIG. 2 phantom lines. Reverse the procedure to return the collapsible and portable animal shelter or carrier to the upright configuration as shown in FIG. 2 and FIG. 4 by reversing the procedure. Lift the side panels 36 to the vertical position and then pull the front panel up to the vertical position. The end flap of 36 will then snap over the inner locking tabs 16 and stop on the outer roof locking tabs 16 retaining the front panel 36 in the vertical position. Repeat the same for back panel and flap 36. It can be seen from the preceding description that a collapsible, portable animal shelter or carrier has been provided.

Assembly of the carrier is thus accomplished with very few motions once the carrier is manufactured. So, the carrier need only be unfolded to the open position, and the back panel and end flap 36 raised until back panel and end panel 36 are engaged between sets of locking tabs 16. Similarly, disassembly is accomplished by pushing locking tabs 16 back into position (back into their positions within the side and/or roof panel), releasing back panel and end panel 36 which can be folded flat, and thus in the storage position.

It is noted that the embodiment of the collapsible, portable animal shelter or carrier described herein in detail for exemplary purposes is of course subject to many different variations in structure, design, application and methodology because many varying and different embodiments may be made within the scope of the inventive concept (s) herein taught, and because many modifications may be made in the embodiment herein detailed in accordance with the descriptive requirements of the law, it is to be understood that the details herein are to be interpreted as illustrative and not in a limiting sense.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

The invention claimed is:

1. A collapsible, portable animal shelter or carrier comprising
a unitary cut-out member having a number of crease lines, locking tabs formed by cuts in the roof, and protruding from the inside of said cut-out member, a glue covered attachment tab, air holes, two hand hold holes, and a moveable, lockable animal access door arranged thereon such that the cut-out member may be folded and partitions thereof secured together by the glue covered attachment tab and locking tabs to form a collapsible, portable animal shelter or carrier having air holes, a carrying handle formed from the two hand holes, and an animal access door.

2. A collapsible, portable animal shelter or carrier comprising
a cut-out member having a number of crease lines, locking tabs formed by cuts in said cut-out member, permitting the tabs to protrude from the inside of said cut-out member, a glue covered attachment tab, air holes, two hand hold holes, and a moveable, lockable animal access door arranged thereon such that the cut-out member may be folded and partitions thereof secured together by the glue covered attachment tab and locking tabs to form a collapsible, portable animal shelter or carrier having air holes, a carrying handle formed from the two hand holes, and an animal access door, wherein said animal access door further comprises a hinge connecting said door to said cut-out member.

3. A collapsible, portable animal shelter or carrier comprising
a cut-out member comprised of a continuous piece of material and having a number of crease lines, locking tabs formed by cuts in said cut-out member, enabling them to protrude from the inside of said cut-out member, a glue covered attachment tab, air holes, two hand hold holes, and a moveable, lockable animal access door arranged thereon such that the cut-out member may be folded and partitions thereof secured together by the glue covered attachment tab and locking tabs to form a collapsible, portable animal shelter or carrier having air holes, a carrying handle formed from the two hand holes, and an animal access door.

4. A collapsible, portable animal shelter or carrier comprising
a cut-out member comprised of a continuous piece of material and having a number of crease lines, locking tabs formed in said cut-out member, a glue covered attachment tab, air holes, two hand hold holes, and a moveable, animal access door arranged thereon such that the cut-out member may be folded and portions thereof secured together by the glue covered attachment tab and locking tabs to form a collapsible, portable animal shelter or carrier having air holes, a carrying handle formed from the two hand holes, and an animal access door.

5. A collapsible, portable animal shelter or carrier comprising
a cut-out member comprised of a single continuous piece of material and having a number of crease lines, locking tabs formed in said cut-out member, air holes, at least one hand hold hole, and a moveable, animal access door arranged thereon such that the cut-out member may be folded and portions thereof secured together by the locking tabs to form said collapsible, portable animal shelter or carrier.

6. The collapsible, portable animal shelter or carrier of claim 5 wherein said animal access door is lockable.

7. The collapsible, portable animal shelter or carrier of claim 5 wherein said locking tabs are cut into said cut-out member and which can be manipulated to create a channel within which another portion of said cut-out member may be secured.
